(19) United States
(12) Patent Application Publication
(10) Pub. No.: US 2022/0340232 A1
(43) Pub. Date: Oct. 27, 2022

(54) SHIFT CONTROL DEVICE OF VEHICLE

(71) Applicant: KWANG YANG MOTOR CO., LTD., Kaohsiung (TW)

(72) Inventors: Feng-Chih TSAI, Kaohsiung City (TW); Hao-Yu WU, Kaohsiung (TW); Wei-Xiang LIAO, Kaohsiung (TW)

(21) Appl. No.: 17/720,336

(22) Filed: Apr. 14, 2022

(30) Foreign Application Priority Data
Apr. 21, 2021 (TW) 110204393

(51) Int. Cl. B62M 25/06; F16H 61/32; B62M 25/08; F16H 59/04

(52) U.S. Cl. CPC B62M 25/06; F16H 61/32; B62M 25/08; F16H 59/04

(57) ABSTRACT

The present invention provides a shift control device of a vehicle mounted to a body of a vehicle and having a gearbox, a shift actuator, a base, a gearshift lever, and a gearshift detector. The gearshift lever is disposed on the base. The gearshift detector is electrically connected to the shift actuator. The gearshift lever has a shift pedal, the shift pedal has a pivot portion, and the shift pedal is connected pivotally to the base by the pivot portion. The gearshift detector has a rotating element, and the rotating element is rotated coaxially with the pivot portion of the shift pedal. In the shift control device of a vehicle of the present invention, a signal wire will not be wrapped with other components, so transmission errors of mechanisms are reduced, and the structure is simple.

### BACKGROUND OF THE INVENTION

### 1. Field of the Invention

The present invention relates to a shift control device of a vehicle, and more particularly to a shift control device of a vehicle that can prevent a signal wire of a gearshift detector from wrapping around other components, can reduce transmission errors between mechanisms of the vehicle, and have a simple structure.

### 2. Description of Related Art

A conventional shift control device is disclosed in FIG. 1 of US Pub. No. 2019/0264803 A1 and mainly has a gearshift lever 20, a link rod 35, and a gearshift sensor 47. The gearshift lever 20 has a pedal part 33. The link rod 35 is connected to the pedal part 33. The gearshift sensor 47 is disposed on the link rod 35. The link rod 35 is stretched after the pedal part 33 of the gearshift lever 20 is trampled by a user, and the gearshift sensor 47 senses a length change value of the link rod 35 and converts the length change value into a voltage signal. Then the voltage signal is transmitted to an automatic shift control unit to achieve shifting. However, during the process of lengthening or shortening the length of the link rod 35, a signal wire of the gearshift sensor 47 is often wrapped around other components, which causes inconvenience in assembly and maintenance. In addition, the pedal part 33 is rotated relative to a body of a vehicle, and the link rod 35 is lengthened or shortened along an axial direction. The two said components move in different axial directions, which may easily lead to transmission errors of mechanism.

Another conventional shift control device is disclosed in FIG. 16 of U.S. Pat. No. 9,022,163 B2 and mainly has a pedal portion 202, a detector 117, and a conversion mechanism. The pedal portion 202 is connected to the detector 117 via the conversion mechanism. When the user tramples the pedal portion 202, the action of the pedal portion 202 is transmitted to the detector 117 through the conversion mechanism. However, the structure of the conversion mechanism is too complicated, with too many components, heavy weight, increases cost, and occupies too much space.

Therefore, the conventional shift control device of the vehicle needs improvement.

### SUMMARY OF THE INVENTION

### Problem to be Solved

The main objective of the present invention is to provide a shift control device of a vehicle that overcomes the shortcomings that the conventional shift control device uses the gearshift sensor to detect the length change value of the link rod, the signal wire of the gearshift sensor is wrapped around other components when the gearshift sensor transmits a signal to the automatic shift control unit to shift, inconvenient maintenance, and the pedal part and the link rod moved in different axial directions may easily lead to transmission errors of mechanism, or the conversion mechanism is too complicated, with too many components, heavy weight and increased cost, and occupies too much space.

### Technical Solution Solving the Problem

The present invention provides a shift control device of a vehicle, adapted to dispose on a body of a vehicle and comprising a gearbox, a shift actuator, a base, a gearshift lever, and a gearshift detector, the shift actuator driving the gearbox, the gearshift lever disposed on the base, the gearshift detector electrically connected to the shift actuator, and characterized in that:

the gearshift lever has a shift pedal, the shift pedal has a pivot portion, and the shift pedal is connected pivotally to the base by the pivot portion; and

the gearshift detector has a rotating element, and the rotating element is rotated coaxially with the pivot portion of the shift pedal.

Further, for the shift control device of the vehicle as described above, the gearshift lever has a link rod, the link rod is connected to the pivot portion of the shift pedal and the rotating element of the gearshift detector, and the rotating element is rotated coaxially with the shift pedal via the link rod.

Furthermore, for the shift control device of the vehicle as described above, the shift pedal has a connecting recess, the connecting recess has at least one first abutting face formed in an internal surface of the connecting recess, the link rod has at least one second abutting face, and the at least one second abutting face abuts against the at least one first abutting face when the link rod passes through the connecting recess of the shift pedal.

Moreover, for the shift control device of the vehicle as described above, the link rod has an engaging portion, the rotating element of the gearshift detector has a holding portion, the holding portion engages with the engaging portion of the link rod, and the rotating element is rotated with the engaging portion of the link rod via the holding portion.

Preferably, for the shift control device of the vehicle as described above, the engaging portion is a rectangular protrusion that extends and protrudes along an axial direction of the link rod, and the holding portion is a rectangular recess corresponding to a shape of the engaging portion and is mounted around the engaging portion.

Preferably, for the shift control device of the vehicle as described above, the shift control device has an outer cover, and the outer cover covers the gearshift detector.

Preferably, for the shift control device of the vehicle as described above, the gearshift detector is disposed between the shift pedal and the body.

Preferably, for the shift control device of the vehicle as described above, the base has at least two locked points, and the base is connected to the body by the at least two locked points.

Preferably, for the shift control device of the vehicle as described above, the base has a pedal bracket, and the shift pedal of the gearshift lever and the gearshift detector are both connected to the pedal bracket.

Preferably, for the shift control device of the vehicle as described above, the shift control device has a first sealing ring and a second sealing ring, the first sealing ring is disposed between the shift pedal and the pedal bracket and is mounted around the link rod, and the second sealing ring is mounted on the external surface of the gearshift detector and is disposed between the external surface of the gearshift detector and the pedal bracket.

Preferably, for the shift control device of the vehicle as described above, the gearshift lever has a connecting shaft, an end of the connecting shaft is connected to the shift pedal, and another end of the connecting shaft is connected to the gearbox.

Preferably, for the shift control device of the vehicle as described above, the gearshift has a length direction, and the length direction of the gearshift detector is parallel to a width direction of the body.

### Efficacy of the Invention

By means of the aforementioned technical features, the present invention provides efficacy as follows:

1. Contrary to the conventional shift control device, the length change value of the link rod is detected by the gearshift sensor when the link rod is driven by the pedal part, the gearshift sensor transmits a signal to the automatic shift control unit to shift, and the signal wire of the gearshift sensor is wrapped around other components. Furthermore, the pedal part and the link rod move in different axial directions, which may easily lead to transmission errors of mechanism. The shift control device in the present invention uses the gearshift detector to sense a rotating angle, the rotating element of the shift detector is rotated coaxially with the pivot portion of the shift pedal, the signal wire of the shift detector will not wrap around other components during transmission, the rotating element and the pivot portion of the shift pedal perform coaxial movement, and the transmission errors of mechanism can be reduced.

2. The structure of the conversion mechanism of the conventional shift control device is too complicated. In the shift control device of the present invention, the rotating element of the gearshift detector and the pivot portion of the shift pedal are connected to each other by the link rod. The structure is simple, the weight and cost can be reduced, and the occupied space can be reduced.

3. The engagement between the at least one second abutting face of the link rod and the at least one first abutting face of the shift pedal and the engagement between the engaging portion of the link rod and the rotating element of the gearshift detector can prevent the link rod from sliding relative to the shift pedal and prevent the rotating element from sliding relative to the link rod while the rotating element of the gearshift detector is rotating coaxially with the shift pedal via the link rod. Then the rotating element, the link rod, and the shift pedal can be rotated synchronously to further reduce the transmission errors of mechanism.

4. The base is connected to the body by the at least two locked points, and the shift pedal of the gearshift lever and the gearshift detector are both connected to the pedal bracket of the base. When the shift pedal and the gearshift detector need to be repaired, the shift pedal and the gearshift detector can be disassembled by directly disassembling the base to facilitate maintenance.

### BRIEF DESCRIPTION OF THE DRAWINGS

FIG. 1 is a side view of a shift control device of a vehicle in accordance with the present invention;

FIG. 2 is an enlarged side view of the shift control device in FIG. 1;

FIG. 3 is a circuit block diagram of a gearshift detector, a shift actuator, and a gearbox of the shift control device in FIG. 1;

FIG. 4 is an enlarged perspective view of the shift control device in FIG. 1;

FIG. 5 is another enlarged perspective view of the shift control device in FIG. 1;

FIG. 6 is an exploded perspective view of the shift control device in FIG. 4;

FIG. 6A is an enlarged perspective view of the shift control device in FIG. 6;

FIG. 7 is an exploded perspective view of a shift pedal and a link rod of the shift control device in FIG. 1; and

FIG. 8 is a rear side view in partial section of the shift control device in FIG. 1.

### DETAILED DESCRIPTION OF THE PREFERRED EMBODIMENT

To understand the technical features of the present invention and utility effects thereof and enable the present invention according to the specification, detailed descriptions of preferred embodiments shown in the drawings are hereinafter described.

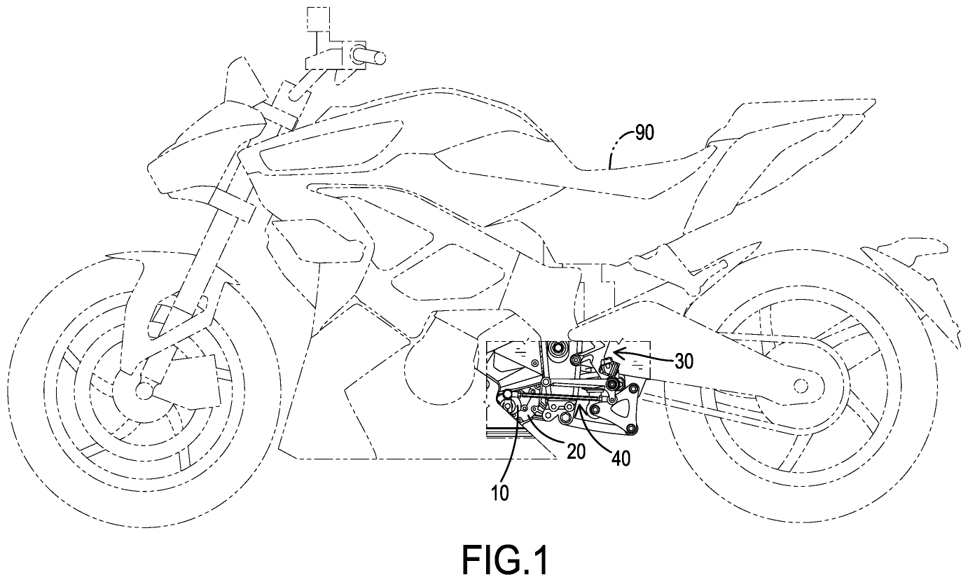

With reference to FIGS. 1, 3, and 4 to 6A, a shift control device of a vehicle in accordance with the present invention is mounted to a body 90 of a vehicle, and comprises a gearbox 10, a shift actuator 20, a base 30, a gearshift lever 40, a gearshift detector 50, an outer cover 60, a first sealing ring 70, and a second sealing ring 80.

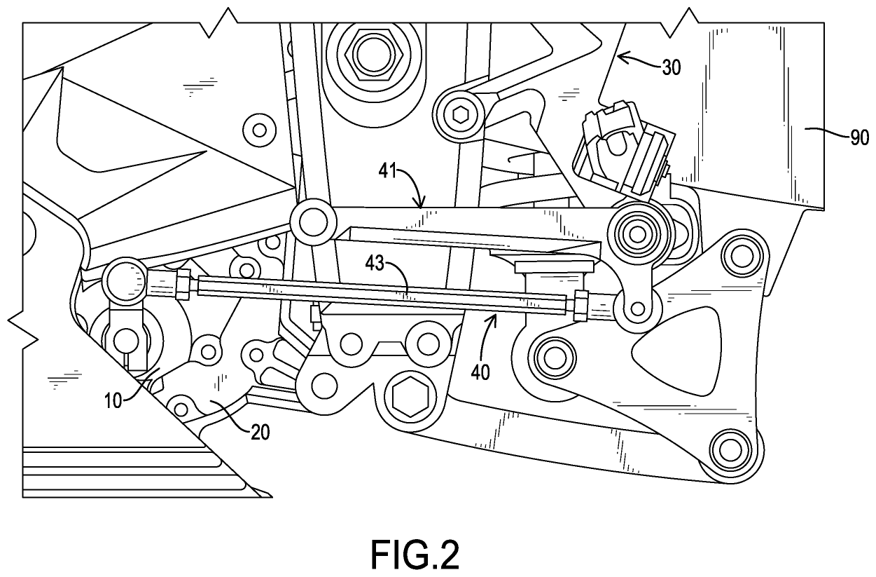

With reference to FIGS. 1 and 2, the gearbox 10 is disposed adjacent to a bottom of the body 90.

With reference to FIGS. 1 to 3, the shift actuator 20 is disposed on the body 90, is spaced apart from the gearbox 10, and is used to drive the gearbox 10. In a preferred embodiment of the present invention, the shift actuator 20 is a motor.

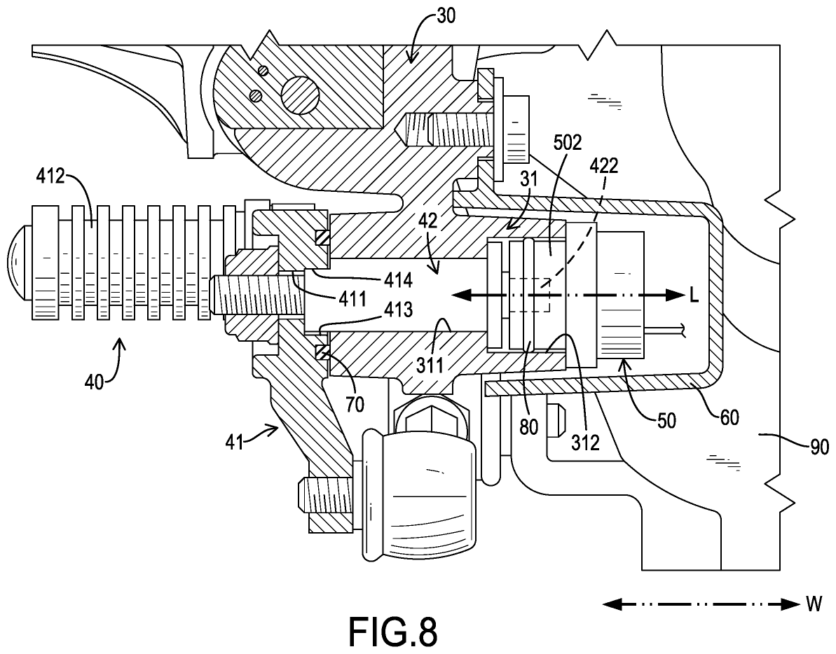

With reference to FIGS. 1, 2, 4, and 5, the base 30 is disposed adjacent to the bottom of the body 90, is disposed on a side of the gearbox 10, and is spaced apart from the shift actuator 20. The base 30 has a pedal bracket 31 and at least two locked points 32. With reference to FIG. 8, the pedal bracket 31 is disposed on a lower half of the base 30 and has a channel 311 and a mounting recess 312 which communicate with each other. The at least two locked points 32 are disposed on an upper half of the base 30 at a spaced interval, and the base 30 is connected to the body 90 via the at least two locked points 32, so a user can disassemble the base 30 from the body 90.

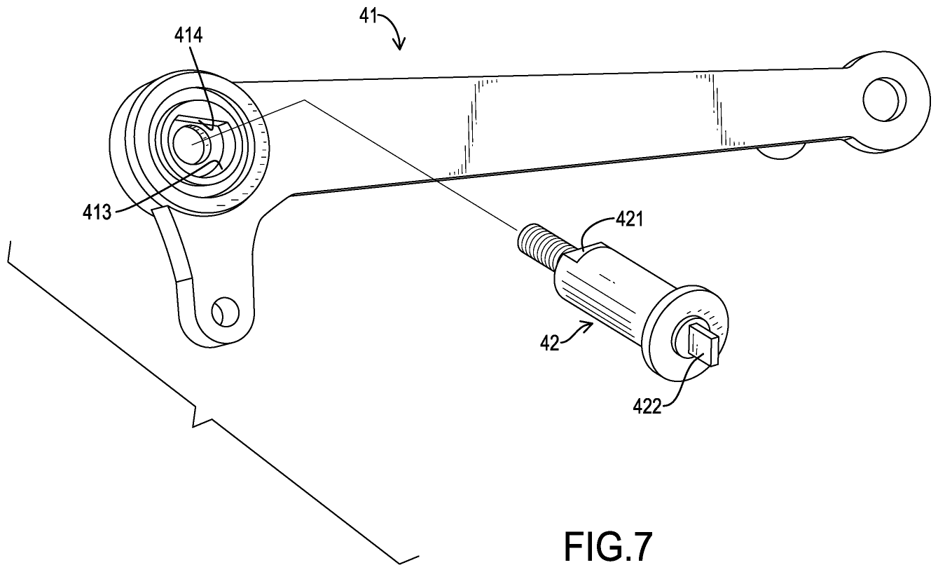

With reference to FIGS. 2, 4, 6, and 8, the gearshift lever 40 is connected to the base 30 and has a shift pedal 41, a link rod 42, and a connecting shaft 43. The shift pedal 41 has a pivot portion 411 and a pedal portion 412. The pivot portion 411 is disposed on the shift pedal 41 adjacent to an end thereof. The shift pedal 41 is pivotally connected to the pedal bracket 31 of the base 30 by the pivot portion 411. The pedal portion 412 is disposed on an end of the shift pedal 41 away from the pivot portion 411 and extends away from the body 90. Furthermore, with reference to FIGS. 7 and 8, the shift pedal 41 has a connecting recess 413. The connecting recess 413 is formed in a side of the shift pedal 41 facing the body 90, is coaxially disposed with the pivot portion 411, and has at least one first abutting face 414 formed in an internal surface of the connecting recess 413. The link rod 42 extends through the pedal bracket 31 of the base 30 and the connecting recess 413 and the pivot portion 411 of the shift pedal 41, and has at least one second abutting face 421 and an engaging portion 422. The at least one second abutting face 421 is formed on an external surface of the link rod 42 and abuts against the at least one first abutting face 414 after the link rod 42 passes through the connecting recess 413 of the shift pedal 41. Therefore, when the shift pedal 41 is rotated pivotally relative to the base 30, the shift pedal 41 and the link rod 42 can be ensured to rotate synchronously. Furthermore, the connecting recess 413 may have multiple first abutting faces 414, and the link rod 42 may have multiple second abutting faces 421 corresponding to the multiple first abutting faces 414 of the connecting recess 413. As long as the internal surface of the connecting recess 413 and the external surface of the link rod 42 are all non-circular structures, the shift pedal 41 can drive the link rod 42 to rotate synchronously without sliding relative to each other, which is the object to be protected in the present invention.

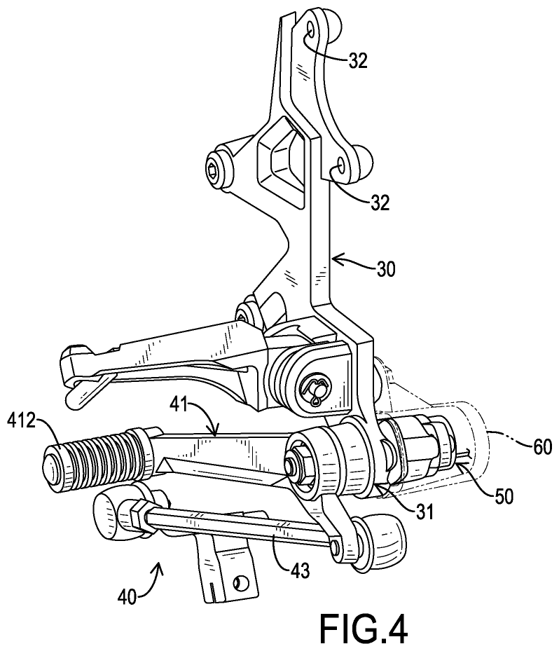

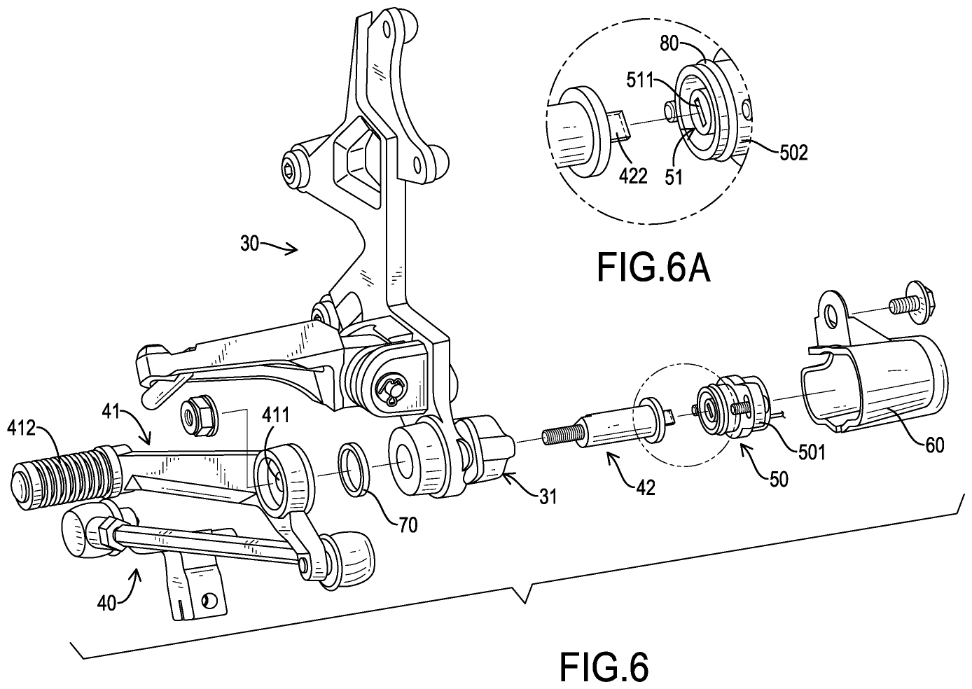

With reference to FIGS. 6 to 8, the engaging portion 422 is formed on and protruded from an end of the link rod 42 away from the shift pedal 41, and the engaging portion 422 is a rectangular protrusion that extends and protrudes along an axial direction of the link rod 42. With reference to FIGS. 2 and 4, an end of the connecting shaft 43 is connected to the shift pedal 41, and another end of the connecting shaft 43 is connected to the gearbox 10 to control the shifting of the gearbox 10. The shifting of the gearbox 10 controlled by the connecting shaft 43 is conventional and is not to be described in detail.

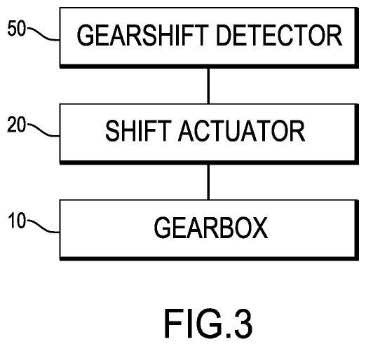

With reference to FIGS. 3, 4, 5, 6, and 8, the gearshift detector 50 is a detector that senses a rotation angle, is disposed on the pedal bracket 31 of the base 30 between the shift pedal 41 and the body 90, and is electrically connected to the shift actuator 20. The gearshift detector 50 has a fixing element 501 and a neck portion 502 protruded from the fixing element 501 and inserted in the mounting recess 312. The gearshift detector 50 has a length direction L and a rotating element 51. With reference to FIG. 8, the length direction L of the gearshift detector 50 is parallel to a width direction W of the body 90, and the rotating element 51 is rotated around the length direction L of the gearshift detector 50. With reference to FIGS. 6 and 6A, the rotating element 51 can be rotated relative to the gearshift detector 50 and has a holding portion 511. The holding portion 511 engages with the engaging portion 422 of the link rod 42, and the link rod 42 can drive the rotating element 51 to rotate by an engagement between the engaging portion 422 and the holding portion 511. Therefore, the shift pedal 41 can drive the rotating element 51 of the gearshift detector 50 to rotate coaxially via the link rod 42, so that the rotating element 51 and the pivot portion 411 of the shift pedal 41 of the gearshift lever 40 can rotate coaxially. In addition, the holding portion 511 is a rectangular recess corresponding to a shape of the engaging portion 422, and the holding portion 511 is mounted around the engaging portion 422. After the user tramples the pedal portion 412 of the shift pedal 41, the shift pedal 41 is rotated pivotally relative to the base 30, and the rotating element 51 of the gearshift detector 50 is rotated coaxially and synchronously with the shift pedal 41 via the link rod 42. Then the gearshift detector 50 transmits a signal related to a rotation angle to the shift actuator 20, and the shift actuator 20 then controls the shifting of the gearbox 10. Since the rotating element 51 is rotated coaxially with the pivot portion 411 of the shift pedal 41 and has the same rotation angle, the transmission error between the mechanisms can be reduced.

In other preferred embodiments, the link rod 42 is integrally formed on the shift pedal 41. When the user tramples the shift pedal 41, the link rod 42 can be rotated synchronously with the shift pedal 41.

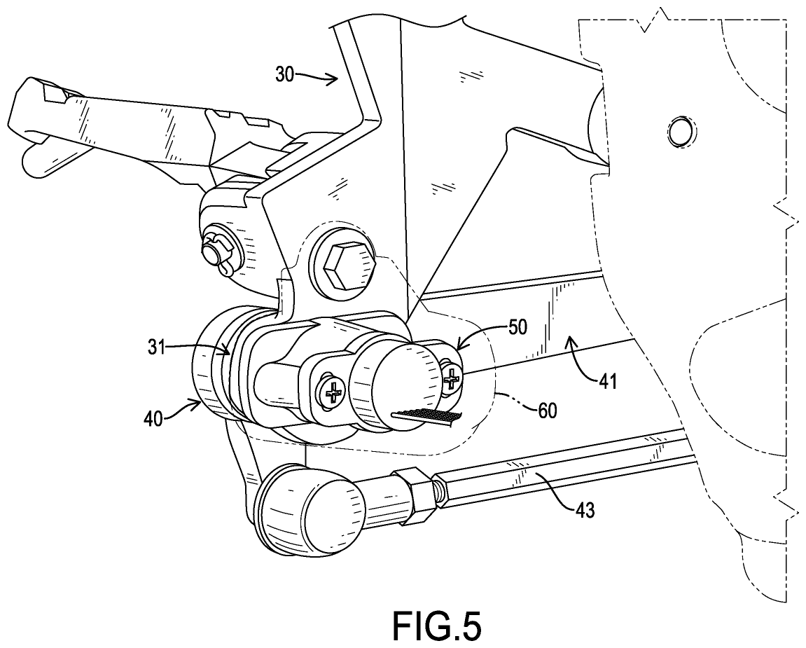

With reference to FIGS. 5, 6, and 8, the outer cover 60 is disposed on a side of the pedal bracket 31 of the base 30 away from the shift pedal 41 to cover the gearshift detector 50 to prevent moisture and dust from entering the gearshift detector 50.

With reference to FIGS. 6 and 8, the first sealing ring 70 is engaged on a side of the shift pedal 41 facing the pedal bracket 31 between the shift pedal 41 and the pedal bracket 31 and is mounted around the connecting recess 413 and the link rod 42 that is inserted in the connecting recess 413 to prevent moisture and dust from entering the gearshift detector 50 through a gap between the shift pedal 41 and the pedal bracket 31 and a gap between the link rod 42 and the pedal bracket 31. Furthermore, the first sealing ring 70 is a washer. The second sealing ring 80 is mounted on an external surface of the neck portion 502 between the mounting recess 312 of the pedal bracket 31 and the external surface of the neck portion 502. In this way, in addition to the protection of the outer cover 60, the second sealing ring 80 can prevent moisture and dust from entering the gearshift detector 50 through a gap between the pedal bracket 31 and the gearshift detector 50. Furthermore, the second sealing ring 80 is an O-ring.

With reference to FIGS. 6 and 8, when a user wants to shift, the pedal portion 412 of the shift pedal 41 is trampled by the user, the rotating element 51 of the gearshift detector 50 is rotated coaxially with the shift pedal 41 via the link rod 42, and the gearshift detector 50 transmits a signal to the shift actuator 20 to achieve the purpose of shifting. If the gearshift detector 50 fails to transmit signals, the gearbox 10 is driven to shift by the connecting shaft 43.

By means of the aforementioned technical features, the present invention provides efficacy as follows:

1. Contrary to the conventional shift control device, the length change value of the link rod is detected by the gearshift sensor when the link rod is driven by the pedal part, the gearshift sensor transmits a signal to the automatic shift control unit to shift, and the signal wire of the gearshift sensor is wrapped around other components. Furthermore, the pedal part and the link rod move in different axial directions, which may easily lead to transmission errors of mechanism. The shift control device in the present invention uses the gearshift detector 50 to sense a rotating angle, the rotating element 51 of the shift detector 50 is rotated coaxially with the pivot portion 411 of the shift pedal 41, the signal wire of the shift detector 50 will not wrap around other components during transmission, the rotating element 51 and the pivot portion 411 of the shift pedal 41 perform coaxial movement, and the transmission errors of mechanism can be reduced.

2. The structure of the conversion mechanism of the conventional shift control device is too complicated. In the shift control device of the present invention, the rotating element 51 of the gearshift detector 50 and the pivot portion 411 of the shift pedal 41 are connected to each other by the link rod 42. The structure is simple, the weight and cost can be reduced, and the occupied space can be reduced.

3. The engagement between the at least one second abutting face 421 of the link rod 42 and the at least one first abutting face 414 of the shift pedal 41 and the engagement between the engaging portion 422 of the link rod 42 and the rotating element 51 of the gearshift detector 50 can prevent the link rod 42 from sliding relative to the shift pedal 41 and prevent the rotating element 51 from sliding relative to the link rod 42 while the rotating element 51 of the gearshift detector 50 is rotating coaxially with the shift pedal 41 via the link rod 42. Then the rotating element 51, the link rod 42, and the shift pedal 41 can be rotated synchronously to further reduce the transmission errors of mechanism.

4. The base 30 is connected to the body 90 by the at least two locked points 32, and the shift pedal 41 of the gearshift lever 40 and the gearshift detector 50 are both connected to the pedal bracket 31 of the base 30. When the shift pedal 41 and the gearshift detector 50 need to be repaired, the shift pedal 41 and the gearshift detector 50 can be disassembled by directly disassembling the base 30 to facilitate maintenance.

Through foregoing paragraphs, the preferred embodiments and detailed descriptions thereof are described for presenting the technical means adopted by the present invention to solve the problem, not to constrain the scope of the claimed invention. Anything that is literally consistent with the claims of the present invention and variations and modifications that are equivalent to the claims are encompassed by the scope of the claims of the present invention.

What is claimed is:

1. A shift control device of a vehicle, the shift control device adapted to dispose on a body of a vehicle and comprising a gearbox, a shift actuator, a base, a gearshift lever, and a gearshift detector, the shift actuator driving the gearbox, the gearshift lever disposed on the base, the gearshift detector electrically connected to the shift actuator, and characterized in that:
the gearshift lever has a shift pedal, the shift pedal has a pivot portion, and the shift pedal is connected pivotally to the base by the pivot portion; and
the gearshift detector has a rotating element, and the rotating element is rotated coaxially with the pivot portion of the shift pedal.

2. The shift control device of the vehicle as claimed in claim 1, wherein the gearshift lever has a link rod, the link rod is connected to the pivot portion of the shift pedal and the rotating element of the gearshift detector, and the rotating element is rotated coaxially with the shift pedal via the link rod.

3. The shift control device of the vehicle as claimed in claim 2, wherein the shift pedal has a connecting recess, the connecting recess has at least one first abutting face formed in an internal surface of the connecting recess, the link rod has at least one second abutting face, and the at least one second abutting face abuts against the at least one first abutting face when the link rod passes through the connecting recess of the shift pedal.

4. The shift control device of the vehicle as claimed in claim 2, wherein the link rod has an engaging portion, the rotating element of the gearshift detector has a holding portion, the holding portion engages with the engaging portion of the link rod, and the rotating element is rotated with the engaging portion of the link rod via the holding portion.

5. The shift control device of the vehicle as claimed in claim 4, wherein the engaging portion is a rectangular protrusion that extends and protrudes along an axial direction of the link rod, and the holding portion is a rectangular recess corresponding to a shape of the engaging portion and is mounted around the engaging portion.

6. The shift control device of the vehicle as claimed in claim 1, wherein the shift control device has an outer cover, and the outer cover covers the gearshift detector.

7. The shift control device of the vehicle as claimed in claim 2, wherein the shift control device has an outer cover, and the outer cover covers the gearshift detector.

8. The shift control device of the vehicle as claimed in claim 3, wherein the shift control device has an outer cover, and the outer cover covers the gearshift detector.

9. The shift control device of the vehicle as claimed in claim 4, wherein the shift control device has an outer cover, and the outer cover covers the gearshift detector.

10. The shift control device of the vehicle as claimed in claim 1, wherein the gearshift detector is disposed between the shift pedal and the body.

11. The shift control device of the vehicle as claimed in claim 2, wherein the gearshift detector is disposed between the shift pedal and the body.

12. The shift control device of the vehicle as claimed in claim 3, wherein the gearshift detector is disposed between the shift pedal and the body.

13. The shift control device of the vehicle as claimed in claim 4, wherein the gearshift detector is disposed between the shift pedal and the body.

14. The shift control device of the vehicle as claimed in claim 1, wherein the base has at least two locked points, and the base is connected to the body by the at least two locked points.

15. The shift control device of the vehicle as claimed in claim 2, wherein the base has at least two locked points, and the base is connected to the body by the at least two locked points.

16. The shift control device of the vehicle as claimed in claim 3, wherein the base has at least two locked points, and the base is connected to the body by the at least two locked points.

17. The shift control device of the vehicle as claimed in claim 4, wherein the base has at least two locked points, and the base is connected to the body by the at least two locked points.

18. The shift control device of the vehicle as claimed in claim 2, wherein the base has a pedal bracket, and the shift pedal of the gearshift lever and the gearshift detector are both connected to the pedal bracket.

19. The shift control device of the vehicle as claimed in claim 3, wherein the base has a pedal bracket, and the shift pedal of the gearshift lever and the gearshift detector are both connected to the pedal bracket.

20. The shift control device of the vehicle as claimed in claim 4, wherein the base has a pedal bracket, and the shift pedal of the gearshift lever and the gearshift detector are both connected to the pedal bracket.

21. The shift control device of the vehicle as claimed in claim 18, wherein the shift control device has a first sealing ring and a second sealing ring, the first sealing ring is disposed between the shift pedal and the pedal bracket and is mounted around the link rod, and the second sealing ring is mounted on the external surface of the gearshift detector and is disposed between the external surface of the gearshift detector and the pedal bracket.

22. The shift control device of the vehicle as claimed in claim 19, wherein the shift control device has a first sealing ring and a second sealing ring, the first sealing ring is disposed between the shift pedal and the pedal bracket and is mounted around the link rod, and the second sealing ring is mounted on the external surface of the gearshift detector and is disposed between the external surface of the gearshift detector and the pedal bracket.

23. The shift control device of the vehicle as claimed in claim 20, wherein the shift control device has a first sealing ring and a second sealing ring, the first sealing ring is disposed between the shift pedal and the pedal bracket and is mounted around the link rod, and the second sealing ring is mounted on the external surface of the gearshift detector and is disposed between the external surface of the gearshift detector and the pedal bracket.

24. The shift control device of the vehicle as claimed in claim 1, wherein the gearshift lever has a connecting shaft, an end of the connecting shaft is connected to the shift pedal, and another end of the connecting shaft is connected to the gearbox.

25. The shift control device of the vehicle as claimed in claim 2, wherein the gearshift lever has a connecting shaft, an end of the connecting shaft is connected to the shift pedal, and another end of the connecting shaft is connected to the gearbox.

26. The shift control device of the vehicle as claimed in claim 3, wherein the gearshift lever has a connecting shaft, an end of the connecting shaft is connected to the shift pedal, and another end of the connecting shaft is connected to the gearbox.

27. The shift control device of the vehicle as claimed in claim 4, wherein the gearshift lever has a connecting shaft, an end of the connecting shaft is connected to the shift pedal, and another end of the connecting shaft is connected to the gearbox.

28. The shift control device of the vehicle as claimed in claim 1, wherein the gearshift has a length direction, and the length direction of the gearshift detector is parallel to a width direction of the body.

29. The shift control device of the vehicle as claimed in claim 2, wherein the gearshift has a length direction, and the length direction of the gearshift detector is parallel to a width direction of the body.

30. The shift control device of the vehicle as claimed in claim 3, wherein the gearshift has a length direction, and the length direction of the gearshift detector is parallel to a width direction of the body.

31. The shift control device of the vehicle as claimed in claim 4, wherein the gearshift has a length direction, and the length direction of the gearshift detector is parallel to a width direction of the body.
